(19) United States
(12) Patent Application Publication
(10) Pub. No.: US 2025/0374233 A1
(43) Pub. Date: Dec. 4, 2025

(54) Location Tracking Across Varying Distances

(71) Applicant: Apple Inc., Cupertino, CA (US)

(72) Inventors: Scott Lopatin, Los Gatos, CA (US); Denver E Cohen, Emerald Hills, CA (US); Biljana Badic, Munich (DE); Lydi Smaini, San Jose, CA (US); Wassim El-Hassan, San Jose, CA (US); Raj Kiran Nadimpalli, Milpitas, CA (US); John W Fenwick, Woodside, CA (US)

(21) Appl. No.: 18/676,350

(22) Filed: May 28, 2024

(51) Int. Cl. H04W 64/00; H04W 84/18

(52) U.S. Cl. CPC H04W 64/006; H04W 84/18

(57) ABSTRACT

A tracking device may be coupled to an item for location tracking. Non-cellular wireless communication circuitry of the tracking device may convey location information to an electronic device for output to a user in tracking the location of the tracking device. Different types of non-cellular wireless communication circuitry, including sub-GHz wireless communication circuitry, may convey location information in different manners to the electronic device to guide the user in finding the tag and the tagged item.

### FIELD

This relates generally to tracking systems that include one or more devices used to track an item.

### BACKGROUND

Tracking devices are sometimes used to keep track of a user's items. For example, a user may attach a tracking device to a set of keys and may be able to determine the location of the keys using an electronic device that receives tracking information from the tracking device.

Conventional tracking systems may be unsatisfactory for a user. In particular, it may be difficult to track items that can move across large distances and/or between different geographical areas in a power-efficient manner, which can be particularly desirable when the tracking device is a small device having limited battery capacity.

### SUMMARY

A tracking device may be attached to an item. The tracking device may operate with an electronic device such that the user of the electronic device can track the location of the tracking device and therefore the location of the item.

The tracking device may include non-cellular wireless communication circuitry such as sub-GHz non-cellular wireless communication circuitry configured to convey radio-frequency signals at one or more frequencies below 1 GHz (e.g., an ISM frequency band around 900 MHz). The sub-GHz non-cellular wireless communication circuitry may transmit beacon messages and/or receive radio-frequency signals transmitted by the electronic device when in range of the sub-GHz non-cellular wireless communication circuitry in order to facilitate the establishment of a direct (peer-to-peer) wireless communication link with the electronic device over which location information of the tracking device can be provided to the electronic device. The provided location information may include a real-time location of the tracking device obtained by satellite navigation circuitry of the tracking device.

If desired, when outside of the range of the sub-GHz non-cellular wireless communication circuitry, other non-cellular wireless communication circuitry such as satellite wireless communication circuitry may convey location information of the tracking device to the electronic device in order to guide the user to close the separation between the tracking device and the electronic device such that the electronic device comes within range of the sub-GHz non-cellular wireless communication circuitry.

Certain types of non-cellular wireless communication circuitry may be enabled (e.g., activated and/or configured) to perform the operations associated with location conveyance responsive to the control circuitry of the tracking device determining that one or more criteria have been met. As examples, the one or more criteria may include one or more criteria that are met when the tracking device crosses a boundary to be outside of a geographical area (e.g., as determined based on sensor data gathered from a motion sensor) and/or may include one or more criteria that are met when the tracking device not wirelessly paired with the electronic device.

### BRIEF DESCRIPTION OF THE DRAWINGS

FIG. 1 is a schematic diagram of an illustrative tracking system containing devices that may be used to keep track of items in accordance with some embodiments.

FIG. 2 is a perspective view of an illustrative electronic device that may be used to keep track of tags and associated tagged items in accordance with some embodiments.

FIG. 3 is a side view of an illustrative tag in accordance with some embodiments.

FIG. 4 is a diagram of an illustrative system in which electronic devices, servers, and tags communicate with one another over a communications network in accordance with some embodiments.

FIG. 5 is a schematic diagram of illustrative non-cellular wireless communication circuitry in a tag in accordance with some embodiments.

FIG. 6 is a diagram of an illustrative system in which an electronic device and a tag are separated by varying degrees of separation in accordance with some embodiments.

FIG. 7 is a diagram of an illustrative tag configured to communicate using sub-GHz non-cellular wireless communication circuitry in accordance with some embodiments.

FIG. 8 is a diagram of an illustrative tag configured to communicate using satellite wireless communication circuitry and/or wireless personal area network communication circuitry in accordance with some embodiments.

FIG. 9 is a diagram of an illustrative tag configured to communicate using ultra-wideband wireless communication circuitry and/or a speaker in accordance with some embodiments.

FIG. 10 is a diagram of an illustrative tag configured to detect tag movement relative to a geographical area in accordance with some embodiments.

FIG. 11 is a diagram of illustrative operating modes of a tag in accordance with some embodiments.

FIG. 12 is a flowchart of illustrative operations for providing location information to an electronic device in accordance with some embodiments.

### DETAILED DESCRIPTION

An electronic device may be used to gather tracking data from one or more tags (sometimes referred to as tracking devices, low-power radio-frequency signal transmitters, beacons, etc.). The tags may be coupled to items such as a user's keys, wallet, purse, backpack, shoes, sunglasses, a pet collar, suitcase, a piece of clothing, or any other suitable items to track the locations of the items. The electronic device may include control circuitry that gathers and processes tag data received from the tags. The tag data may include location information (e.g., historical location data indicating where the tag previously traveled to over a given period of time, real-time location information indicating where the tag is currently located, and/or other location information).

To efficiently provide location information across varying distances between the electronic device and the tag. The tag may include various types of non-cellular wireless communication circuitry such as satellite navigation circuitry and sub-GHz wireless communication circuitry. The sub-GHz wireless communication circuitry may establish a direct (peer-to-peer) wireless communication link with the electronic device, once the electronic device is within range. The satellite navigation circuitry may obtain real-time location information and stream the real-time location information to the electronic device via the wireless communication link. In such a manner, the user of the electronic device may be guided to close the separation between the electronic device and the tag. Once in close proximity, close proximity operations (e.g., precision finding operations using spatial ranging based on ultra-wideband (UWB) communications, using audio output from the tag, etc.) may be performed to facilitate the finding of the tag and the item attached thereto.

To guide the user to carry the electronic device to be within the range of establishing the direct wireless communication link, the tag may use other non-cellular wireless communication circuitry such as satellite wireless communication circuitry and/or Bluetooth communication circuitry to provide location information of the tag to the electronic device.

In such a manner, the various types of non-cellular wireless communication circuitry on the tag may facilitate the conveyance of location information to the electronic device in a power efficient manner across varying distances.

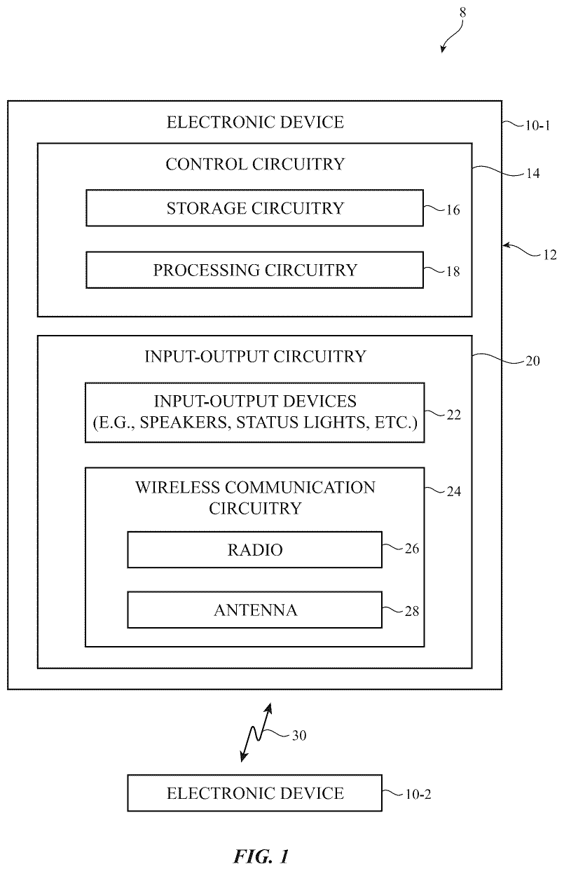

An illustrative tracking system such as system 8 that includes electronic devices 10 (e.g., one or more tracking devices 10-1 and/or one or more user devices 10-2 for locating tracking devices 10-1) is shown in FIG. 1. Electronic device 10 (e.g., electronic device 10-1, electronic device 10-2, and/or generally any electronic device in system 8) may be a computing device such as a laptop computer, a desktop computer, a computer monitor containing an embedded computer, a tablet computer, a cellular telephone, a media player, or other handheld or portable electronic device, a smaller device such as a tag or tracking device, a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment. Some devices 10 in system 8 may be tags or tracking devices, whereas other devices 10 in system 8 may be user devices that operate with the tags to track the locations or otherwise communicate with the tags.

As shown in FIG. 1, an electronic device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Electronic device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within electronic device 10 and/or removable storage media.

Control circuitry 14 may include processing circuitry such as processing circuitry 18. Processing circuitry 18 may be used to control the operation of electronic device 10. Processing circuitry 16 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in electronic device 10 using hardware (e.g., dedicated hardware or circuitry), firmware, and/or software. Software code for performing operations in electronic device 10 may be stored on storage circuitry 16 (e.g., storage circuitry 16 may include non-transitory (tangible) computer-readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as one or more software applications (sometimes referred to herein simply as applications or apps). The applications may be stored at storage circuitry 16. The applications may include satellite navigation applications, internet browsing applications, voice-over-internet-protocol (VOIP) telephone call applications, email applications, media playback applications, operating system functions, gaming applications, productivity applications, workplace applications, augmented reality (AR) applications, extended reality (XR) applications, virtual reality (VR) applications, scheduling applications, consumer applications, social media applications, educational applications, banking applications, spatial ranging applications, sensing applications, security applications, media applications, streaming applications, automotive applications, video editing applications, image editing applications, rendering applications, simulation applications, camera-based applications, imaging applications, news applications, and/or any other desired software applications. The applications may generate and/or receive corresponding wireless data (e.g., when executed by an application processor).

To support interactions with external communications equipment, control circuitry 14 may be used in implementing communications protocols. Communications protocols that may be implemented using control circuitry 14 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, ultra-wideband protocols, cellular (telephone) protocols (e.g., 3G protocols, 3rd Generation Partnership Project (3GPP) Fourth Generation (4G) Long Term Evolution (LTE) protocols, 3GPP Fifth Generation (5G) New Radio (NR) protocols, 6G protocols, cellular sideband protocols, etc.), device-to-device (D2D) protocols, antenna diversity protocols, satellite communications protocols (e.g., for conveying bi-directional data with one or more gateways via one or more communications satellites in a satellite constellation), antenna-based spatial ranging protocols, or any other desired communications protocols. Each communications protocol may be associated with a corresponding radio access technology (RAT) that specifies the physical connection methodology used in implementing the protocol (e.g., an NR RAT, an LTE RAT, a 3G RAT, a WLAN RAT, etc.).

Electronic device 10 may include input-output circuitry 20. Input-output circuitry 20 may include input-output devices 22. Input-output devices 22 may be used to allow data to be supplied to electronic device 10 and to allow data to be provided from electronic device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators or status lights, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to electronic device 10 using wired or wireless connections (e.g., some of input-output devices 22 may be peripherals that are coupled to a main processing unit or other portion of electronic device 10 via a wired or wireless link).

Input-output circuitry 20 may include wireless communication circuitry 24 to support wireless communications. Wireless communication circuitry 24 (sometimes referred to herein as wireless circuitry 24) may include one or more radios 26. Wireless circuitry 24 may also include one or more antennas 28. Radio 26 may include circuitry that operates on signals at baseband frequencies (e.g., baseband circuitry) and radio-frequency transceiver circuitry such as one or more radio-frequency transmitters and one or more radio-frequency receivers. Radio-frequency transmitters may include signal generator circuitry, modulation circuitry, mixer circuitry for upconverting signals from baseband frequencies to intermediate frequencies and/or radio frequencies, amplifier circuitry such as one or more power amplifiers, digital-to-analog converter (DAC) circuitry, control paths, power supply paths, switching circuitry, filter circuitry, and/or any other circuitry for transmitting radio-frequency signals using antenna(s) 28. Radio-frequency receivers may include demodulation circuitry, mixer circuitry for downconverting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antenna(s) 28. The components of radio 26 may be mounted onto a single substrate or integrated into a single integrated circuit, chip, package, or system-on-chip (SOC) or may be distributed between multiple substrates, integrated circuits, chips, packages, or SOCs.

Antenna(s) 28 may be formed using any desired antenna structures for conveying radio-frequency signals. For example, antenna(s) 28 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antenna(s) 28 over time. If desired, two or more of antennas 28 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given/selected beam pointing direction.

The term “convey radio-frequency signals” as used herein means the transmission and/or reception of the radio-frequency signals (e.g., for performing unidirectional and/or bidirectional wireless communications with external wireless communications equipment). Similarly, the term “convey wireless data” as used herein means the transmission and/or reception of wireless data using radio-frequency signals. Antenna(s) 28 may transmit the radio-frequency signals by radiating the radio-frequency signals into free space (or to free space through intervening device structures such as a dielectric cover layer). Antenna(s) 28 may additionally or alternatively receive the radio-frequency signals from free space (e.g., through intervening devices structures such as a dielectric cover layer). The transmission and reception of radio-frequency signals by antennas 28 each involve the excitation or resonance of antenna currents on an antenna resonating element in the antenna by the radio-frequency signals within the frequency band(s) of operation of the antenna.

Each radio 26 may be coupled to one or more antennas 28 over one or more radio-frequency transmission lines. Radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission lines may be integrated into rigid and/or flexible printed circuit boards if desired. One or more radio-frequency transmission lines may be shared between multiple radios 26 if desired. Radio-frequency front end (RFFE) modules may be interposed on one or more radio-frequency transmission lines. The radio-frequency front end modules may include substrates, integrated circuits, chips, or packages that are separate from radios 26 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission lines.

Radio 26 may transmit and/or receive radio-frequency signals within corresponding frequency bands at radio frequencies (sometimes referred to herein as communications bands or simply as “bands”). The frequency bands handled by radio 26 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5 G New Radio Frequency Range 2 (FR2) bands between 20 and 60 GHz, cellular sidebands, 6G bands between 100-1000 GHz (e.g., sub-THz, THz, or THF bands), etc.), other centimeter or millimeter wave frequency bands between 10-300 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, industrial, scientific, and medical (ISM) bands (e.g., under the IEEE 802.XX family of standards) such as an ISM band between around 900 MHz and 950 MHz or other ISM bands, one or more non-cellular (non-cellular-telephone) sub-GHz bands that are less than 1 GHz such as a band between around 800 MHz and 825 MHz, a band between around 860 MHz and 870 MHz, or other non-cellular bands below 1 GHZ (e.g., the ISM band between around 900 MHz and 950 MHz), one or more unlicensed bands, one or more bands reserved for emergency and/or public services, and/or any other desired frequency bands of interest. Wireless circuitry 24 may also be used to perform spatial ranging operations if desired.

The example of FIG. 1 is illustrative and non-limiting. While control circuitry 14 is shown separately from wireless circuitry 24 in the example of FIG. 1 for the sake of clarity, wireless circuitry 24 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24). As an example, control circuitry 14 may include baseband circuitry (e.g., one or more baseband processors), digital control circuitry, analog control circuitry, and/or other control circuitry that forms part of radio 26. The baseband circuitry may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum (NAS) layer. If desired, the PHY layer operations may additionally or alternatively be performed by radio-frequency (RF) interface circuitry in wireless circuitry 24.

While components of device 10 are shown with respect to device 10-1 in the example of FIG. 1. Device 10-2 and more generally other devices 10 in system 8 may have at least some of the same components as shown for device 10-1 and/or may have different components in addition to or instead of at least some of the components of shown or described for device 10-1. In general, any of the components described above in connection with device 10 may be included in any number of devices 10 in system 8.

Pairs of electronic devices 10 (e.g., electronic device 10-1 and 10-2) may communicate wirelessly with each other, e.g., using corresponding wireless communication circuitry 24 on respective devices. In particular, various types of communication links 30 may be established between pairs of electronic devices 10. Some communication links may be direct or peer-to-peer wireless communication links and some communication links may network-based wireless communication links forming a part of network paths (e.g., involving a number of devices such as base station(s) in one or more types of communication networks).

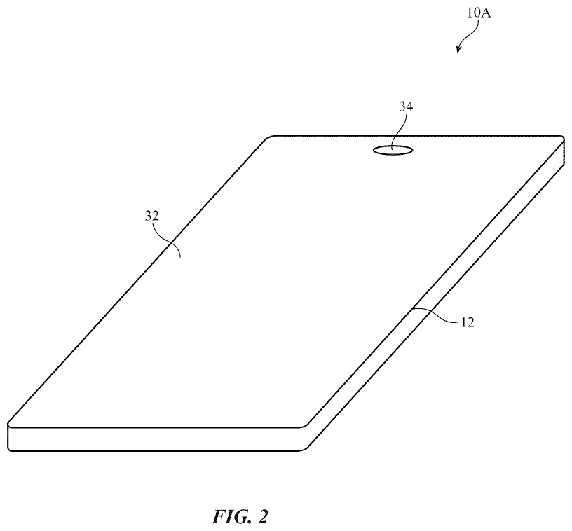

An illustrative type of electronic device 10 in system 8 (FIG. 1) in shown in FIG. 2 as electronic device 10A. In particular, electronic device 10A may be device 10-2 or device 10-1 in FIG. 1. In the illustrative configuration of FIG. 2, device 10A is a portable electronic device such as a cellular telephone, a wristwatch device, media player, tablet computer, or other portable computing device. Other configurations may be used for device 10A if desired. The example of FIG. 2 is merely illustrative.

As shown in FIG. 2, device 10A may include a display such as display 32. Display 32 may be mounted in a housing such as housing 12. For example, device 10A may have opposing front and rear faces and display 32 may be mounted in housing 12 so that display 32 covers the front face of device 10A as shown in FIG. 2. Display 32 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Display 32 may include an array of pixels formed from liquid crystal display (LCD) components, an array of electrophoretic pixels, an array of plasma pixels, an array of organic light-emitting diode pixels, an array of electrowetting pixels, or pixels based on other display technologies.

Display 32 may be protected using a display cover layer such as a layer of transparent glass, clear plastic, sapphire, or other transparent dielectric. Openings may be formed in the display cover layer. As an illustrative example, an opening may be formed in the display cover layer to accommodate a button. If desired, an opening may be formed in the display cover layer to accommodate a port such as speaker port 34. Openings may be formed in housing 12 to form communications ports (e.g., an audio jack port, a digital data port, etc.). Openings in housing 12 may also be formed for audio components such as a speaker and/or a microphone. Dielectric-filled openings such as plastic-filled openings may be formed in metal portions of housing 12 such as in metal sidewall structures (e.g., to serve as antenna windows and/or to serve as gaps that separate portions of antennas from each other).

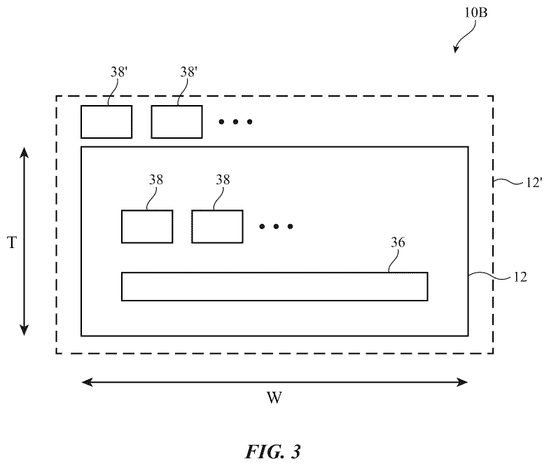

Another illustrative type of electronic device 10 in system 8 (FIG. 1) in shown in FIG. 3 as electronic device 10B. In particular, electronic device 10B may be device 10-1 or device 10-2 in FIG. 1 (and device 10A in FIG. 2 may be the other device). In the illustrative configuration of FIG. 3, device 10B is a tag (sometimes referred to tag 10B, location tracking device 10B, tracking device 10B, low-power transmitter 10B, transmitter 10B, etc.). Other configurations may be used for device 10B if desired. The example of FIG. 3 is merely illustrative.

FIG. 3 shows a side view of illustrative tag 10B. Tag 10B may be worn by or coupled to a person (e.g., a person's wrist, arm, finger, arm, neck, waist, ankle, or other suitable body part), may be worn or coupled to an animal (e.g., cat, dog, etc.), or may be coupled to an object (e.g., a suitcase, key fob, wallet, shoes, clothing, a door knob, an electronic device, or any other suitable object). Tag 10B may be configured to communicate with one or more additional electronic devices such as electronic device 10A of FIG. 2 or generally another device 10 of system 8 of FIG. 1 (e.g., a laptop computer, a computer monitor containing an embedded computer, a tablet computer, a desktop computer, a cellular telephone, a media player, or other handheld or portable electronic device, a smaller device such as a wristwatch device, a pendant device, a headphone or earpiece device, a head-mounted device such as glasses, goggles, a helmet, or other equipment worn on a user's head, or other wearable or miniature device, a television, a computer display that does not contain an embedded computer, a gaming device, a remote control, a navigation device, an embedded system such as a system in which equipment is mounted in a kiosk, in an automobile, airplane, or other vehicle, or equipment that implements the functionality of two or more of these devices).

With one illustrative configuration, which is sometimes described herein as an example, tag 10B is small tracking device coupled to a person, animal, or object (e.g. using a removable case, adhesive, and/or any other suitable attachment structure). Tag 10B may have a circular shape, a round shape, an oval shape, a rectangular shape, and/or other suitable shape. Tag 10B may have a lateral dimension W between 25 mm and 50 mm, between 50 mm and 100 mm, between 10 mm and 200 mm, between 5 mm and 75 mm, less than 50 mm, or greater than 50 mm, and may have a thickness T between 0.1 mm and 1 mm, between 0.5 mm and 2 mm, between 1 mm and 2 mm, between 0.1 mm and 5 mm, greater than 5 mm, or less than 5 mm.

Tag 10B may communicate with one or more electronic devices 10A such as a cellular telephone, tablet computer, laptop computer, wristwatch device, head-mounted device, device with a speaker, or other electronic device (e.g., a device with a display, audio components, and/or other output components). Electronic devices 10A that communicate with tag 10B may sometimes be referred to as host devices. The host devices may run software that is used to track the location of tag 10B, send control signals to tag 10B, receive data from tag 10B, and/or perform other functions related to the operation of tag 10B.

In the example of FIG. 3, tag 10B includes a housing such as housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Tag 10B may include one or more energy storage devices 36. Energy storage devices 36 may include batteries and capacitors. Capacitors for energy storage may be based on supercapacitor structures. Devices 36 may, for example, include super capacitor(s) such as electrostatic double-layer capacitors. Energy storage device 36 may be charged via a wired connection or, if desired, tag 10B may charge energy storage device 36 using wirelessly received power (e.g., inductive wireless power transfer, using capacitive wireless power transfer, and/or other wireless power transfer configurations). In some arrangements, energy storage device 36 is a removable battery that can be replaced. Housing 12 may include a door through which energy storage device 36 may be accessed.

Tag 10B may include components 38 mounted within and/or on housing 12. Components 38 may include electronic components such as integrated circuits, discrete components, light-emitting components, sensors, and/or other circuits and may, if desired, be interconnected using signal paths in one or more printed circuits, may include magnetic components (e.g., magnets), may include mechanical devices, and/or other suitable components. If desired, one or more portions of the housing walls may be transparent to light and/or sound (e.g., so that light associated with an image on a display or other light-emitting or light-detecting component can exit or enter housing 12 as appropriate, so that sound from a speaker in tag 10B can exit housing 12, etc.).

Electrical components 38 may include one or more of (e.g., any combination of, all of, etc.) the components in an electronic device 10 in system 8 of FIG. 1 such as those described in connection with and/or used to implement control circuitry 14, storage circuitry 16, processing circuitry 18, input-output circuitry 20, input-output devices 22, wireless communication circuitry 24, radio 26, antenna 28, etc. The control circuitry (e.g., implemented using components 38) of tag 10B may support the operation of tag 10B. The wireless communication circuitry (e.g., implemented using components 38) of tag 10B may allow tag 10B to communicate with other electronic devices such as device 10A of FIG. 2 or another device 10 in system 8 of FIG. 1. For example, the control circuitry of tag 10B may be used to allow wired and/or wireless control commands and other communications to be received from and/or transmitted to devices such as cellular telephones, tablet computers, laptop computers, desktop computers, head-mounted devices, handheld controllers, wristwatch devices, other wearable devices, keyboards, computer mice, remote controls, speakers, accessory displays, accessory cameras, and/or other electronic devices. The wireless communication circuitry of tag 10B may, for example, wirelessly transmit control signals and other information to external equipment in response to receiving user input or other input from sensors or other devices in components 38.

The input-output circuitry (e.g., implemented using components 38) of tag 10B may be used to allow data to be supplied to tag 10B and to allow data to be provided from tag 10B to external devices. The input-output circuitry may include input devices that gather user input and other input and may include output devices that supply visual output, audio output, haptic output, or other output. As examples, output may be provided using light-emitting diodes (e.g., crystalline semiconductor light-emitting diodes for status indicators and/or displays, organic light-emitting diodes in displays and other components), lasers, and other light-emitting devices, audio output devices (e.g., tone generators and/or speakers), haptic output devices (e.g., vibrators, electromagnetic actuators, piezoelectric actuators, and/or other equipment that supplies a user with haptic output), and other output devices.

The input-output circuitry of tag 10B (e.g., implemented using components 38) may include sensors. Sensors for tag 10B may include force sensors (e.g., strain gauges, capacitive force sensors, resistive force sensors, etc.), audio sensors such as microphones, touch and/or proximity sensors such as capacitive sensors (e.g., a two-dimensional capacitive touch sensor integrated into a display, a two-dimensional capacitive touch sensor and/or a two-dimensional force sensor overlapping a display, and/or a touch sensor or force sensor that forms a button, trackpad, or other input device not associated with a display), and other sensors. Touch sensors for a display or for other touch components may be based on an array of capacitive touch sensor electrodes, acoustic touch sensor structures, resistive touch components, force-based touch sensor structures, a light-based touch sensor, or other suitable touch sensor arrangements. If desired, a display may have a force sensor for gathering force input (e.g., a two-dimensional force sensor may be used in gathering force input on a display). If desired, tag 10B may not include a display and may, in general, include fewer input-output devices than device 10A of FIG. 2.

If desired, the sensors in tag 10B may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors, radio-frequency sensors (e.g., sensors that gather position information, three-dimensional radio-frequency images, and/or other information using radar principals or other radio-frequency sensing), depth sensors (e.g., structured light sensors and/or depth sensors based on stereo imaging devices), optical sensors such as self-mixing sensors and light detection and ranging (lidar) sensors that gather time-of-flight measurements, humidity sensors, moisture sensors, gaze tracking sensors, three-dimensional sensors (e.g., time-of-flight image sensors, pairs of two-dimensional image sensors that gather three-dimensional images using binocular vision, three-dimensional structured light sensors that emit an array of infrared light beams or other structured light using arrays of lasers or other light emitters and associated optical components and that capture images of the spots created as the beams illuminate target objects, and/or other three-dimensional image sensors), facial recognition sensors based on three-dimensional image sensors, and/or other sensors.

In some configurations, components 38 may include mechanical devices for gathering input (e.g., buttons, joysticks, scrolling wheels, key pads with movable keys, keyboards with movable keys, and other devices for gathering user input). During operation, tag 10B may use sensors and/or other input-output devices implemented using components 38 to gather user input (e.g., buttons may be used to gather button press input, touch and/or force sensors overlapping displays can be used for gathering user touch screen input and/or force input, touch pads and/or force sensors may be used in gathering touch and/or force input, microphones may be used for gathering audio input, etc.). The control circuitry of tag 10B can then take action based on this gathered information (e.g., by transmitting the information over a wired or wireless path to external equipment, by supplying a user with output using a haptic output device, visual output device, an audio component, or other input-output device in housing 12, etc.).

In one illustrative arrangement, which is sometimes described herein as an example, components 38 include a speaker that emits sound through housing 12 (e.g., through perforations in housing 12 or other sound-transparent regions of housing 12). The speaker in tag 10B may, for example, emit sound to help guide a user to the location of tag 10B (and thus the location of the object, animal, or person that tag 10B is coupled to).

If desired, tag 10B may have some or all of the same circuitry as electronic device 10A of FIG. 2 and/or may have additional or different circuitry than that of device 10A shown in FIG. 2 or of device 10-1 shown in FIG. 1. For example, tag 10B may include one or more low-power transmitters (e.g., a Bluetooth® Low Energy transmitter in wireless personal area network wireless communication circuitry, a UWB frequency signal transmitter in UWB wireless communication circuitry, an RFID transmitter, and/or other transmitters) and a battery, but may have fewer input-output devices than device 10A as a cellular telephone (e.g., may not include a display).

Because tracking devices such as tag 10B of FIG. 3 may sometimes be referred to as tags, the items to which the tags are attached may sometimes be referred to as “tagged items.” As examples, tags 10B may be adhesively attached to items, looped around or tied to items, located inside of items, sewn or stitched to items, magnetically attached to items, hooked onto items, and/or otherwise removably or permanently coupled to items.

In some illustrative configurations, one or more tags 10B may be inserted into or held within an additional external enclosure, holder, or carrier having a housing layer 12′. Housing layer 12′ of tag carrier may be formed from any suitable combination of materials such as fabric, plastic, metal, etc. The tag carrier may help facilitate attachment of tag 10B to the tagged item. As an illustrative example, the tag carrier may be a pet collar having a pocket or other feature to facilitate insertion of tag 10B within layer 12′ and may be used to track an animal or pet using tag 10B. If desired, the tag carrier may include supplemental components 38′ (e.g., supplemental antennas, supplemental wireless communication circuitry, supplemental sensors, supplemental input-output circuitry, supplemental energy storage devices, and/or any of the circuitry or devices described in connection with components 38 in tag 10B) to support the operations of and/or enhance the functionality of tag 10B. As one illustrative example, components 38′ may form supplement antenna element(s) coupled to wireless communication circuitry of tag 10B to facilitate a wireless communication link with a satellite base station and/or other external wireless communication equipment.

In other illustrative configurations, tag 10B may be integrated into a larger electronic device such as another larger electronic device 10 in FIG. 1 (e.g., enclosed within housing 12 of that device 10) such that the location of the larger electronic device can be tracked. Accordingly, the supplemental components 38′ may include components of the larger electronic device.

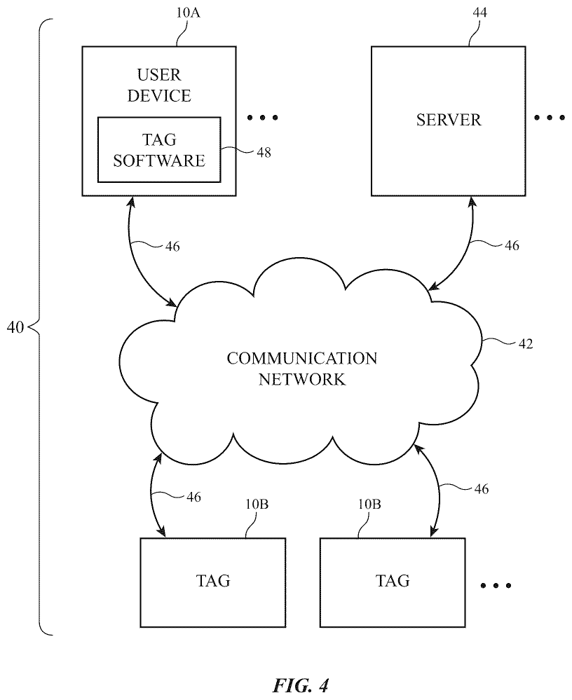

FIG. 4 is a diagram of an illustrative system that may be used to gather and process data associated with one or more tags such as tag 10B of FIG. 3. System 40 may include electronic devices 10 of FIG. 1 (e.g., one or more electronic devices 10A and one or more tags 10B) that communicate with one another over a communication network such as communication network 42. Servers such as servers 44 may be coupled to communication network 42 and (therethrough) to devices 10. Each server 44 may include one or more physical servers and/or one or more virtual servers (e.g., cloud servers) that provide services such as web hosting, data hosting and sharing, software, and/or applications via the internet. Servers 44 may be controlled by a user, may be controlled by a company, may be controlled by a network administrator, and/or may be controlled by any other suitable party.

Tags 10B in system 40 may be used to gather tag data. The tag data may include location information (e.g., historical location data indicating where tag 10B previously traveled to over a given period of time, real-time location information indicating where tag 10B is currently located, and/or other location information), user input information (e.g., user input provided to tag 10B), sensor data (e.g., sensor data gathered with one or more sensors in tag 10B), and/or other data collected by tag 10B. Devices 10A may receive the tag data over communication network 42. In some scenarios, the tag data may be transmitted from tags 10B to servers 44. Servers 44 may process the tag data and provide the processed tag data to device 10A, and/or servers 44 may transmit raw unprocessed tag data to device 10A.

In other scenarios, tags 10B may transmit tag data directly to devices 10A. For example, tag 10B may include one or more low-power transmitters that transmits signals such as signals 46. Device 10A may have a corresponding receiver (e.g., ultra-wideband signal receiver) that detects the transmitted signals from tag 10B and may have control circuitry that determines the location of (and/or other information about) the tag 10B based on the received signals. In some arrangements, tag 10B may not include an internal power source and may instead be powered by electromagnetic energy (e.g., radio frequency waves) from device 10A or other device. In other arrangements, tag 10B may include an internal power source (e.g., energy storage device 36 of FIG. 3).

Electronic devices in system 40 such as devices 10A may serve as host devices that run tag software 48 that is used to track the location of tags 10B, send control signals to tags 10B, receive data from tags 10B, and/or perform other functions related to the operation of tags 10B. Because electronic devices 10A are generally in a user's possession, electronic devices 10A may sometimes be referred to as user electronic devices or user devices 10A.

Equipment in system 40 such as user devices 10A, servers 44, and tags 10B may communicate with one another over communication network 42. Communication network 42 may include one or more wired communications links (e.g., communications links formed using cabling such as ethernet cables, radio-frequency cables such as coaxial cables or other transmission lines, optical fibers or other optical cables, etc.), one or more wireless communications links (e.g., short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles, etc.), switches, routers, servers, modems, repeaters, telephone lines, network cards, line cards, communications gateways, portals, user equipment (e.g., computing devices, mobile devices, etc.), wireless access points, (terrestrial or non-terrestrial) base stations, some or all of a network of communications (network) nodes or terminals coupled together using these components or other components (e.g., some or all of a mesh network, relay network, ring network, local area network, wireless local area network, personal area network, cloud network, star network, tree network, or networks of communications nodes having other network topologies), the Internet, combinations of these, etc.

Electronic devices in system 40 such as user electronic devices 10A, servers and other electronic equipment 44, and tags 10B may communicate over network 42 using communications signals 46. Communications signals 46 may include Bluetooth® signals, near-field communications signals, wireless local area signals such as IEEE 802.11 signals, millimeter wave communication signals such as signals at 60 GHz, ultra-wideband radio frequency signals, other radio-frequency wireless signals, infrared signals, etc. Wireless signals 46 may be used to convey information such as location and orientation information. For example, control circuitry 14 in electronic device 10A may determine the location of tags 10B using wireless signals 46 (e.g., using signal strength measurement schemes by measuring the signal strength of radio signals from tag 10B, using time based measurement schemes such as time of flight measurement techniques, time difference of arrival measurement techniques, angle of arrival measurement techniques, triangulation methods, time-of-flight methods, using a crowdsourced location database, other suitable measurement techniques, etc.). Control circuitry 14 in electronic device 10A may also use image data from image sensors, motion sensor data from motion sensors, and other sensor data (e.g., proximity data from a proximity sensor, etc.) to determine the location of tags 10B in system 40.

Some or all of the devices in system 40 such as user electronic devices 10A, servers 44, and tags 10B may run application software for gathering and/or providing tag-related information. For example, control circuitry 14 in user devices 10A may run tag software 48. Control circuitry 14 in device 10A may execute tag software 48 to gather and process data from tags 10B. Control circuitry 14 in device 10A may also use tag software 48 to provide tag-related output to a user (e.g., real-time location updates for tags 10B, notifications regarding tags 10B, alerts regarding tags 10B, and/or other tag-related output).

In some illustrative configurations described herein as examples, the tagged item and therefore the tag 10B attached to the item may move between different geographical areas and may therefore be separated from the user device 10A by varying distances. While cellular networks provide coverage across vast geographical areas and therefore can be used to convey information between a tag and a corresponding user device operating with the tag (e.g., tracking the location of the tag), this requires that the tag include cellular wireless communication circuitry to connect to and communicate with base stations in the cellular network. However, the active use of the cellular wireless communication circuitry may consume excess power and therefore be particularly undesirable for a small portable device such as a tag having limited space for energy storage devices.

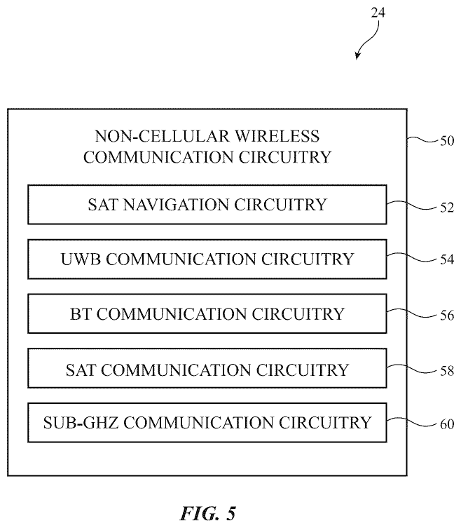

To provide communication in a power-efficient manner, wireless communication circuitry 24 in tag 10B (e.g., implemented using components 38 in FIG. 3) may include various non-cellular wireless communication circuitry. Illustrative types of non-cellular wireless communication circuitry in tag 10B (e.g., that do not establish direct wireless communication links with cellular base stations or generally nodes in cellular telephone networks) are shown in FIG. 5. In the example of FIG. 5, the various types of non-cellular wireless communication circuitry 50 in tag 10B may include satellite (SAT) navigation circuitry 52, UWB wireless communication circuitry 54, Bluetooth (BT) wireless communication circuitry 56, satellite (SAT) wireless communication circuitry 58, and sub-GHz wireless communication circuitry 60.

Satellite navigation circuitry 52 may include portions of wireless circuitry 24 (as described in connection with FIG. 1) configured to perform operations in accordance with satellite navigation system protocols (e.g., global positioning system (GPS) protocols, global navigation satellite system (GLONASS) protocols, etc.) and may generally receive radio-frequency signals having one or more frequencies in one or more satellite navigation frequency bands (e.g., a GPS band from 1565 to 1610 MHz, a Global Navigation Satellite System (GLONASS) band, a BeiDou Navigation Satellite System (BDS) band, etc.). These portions of wireless circuitry 24 may include baseband components, may include radio-frequency receiver components, may include radio-frequency front-end components, may include radio-frequency transmission line components, may include antennas, and/or may generally include any of the components in wireless circuitry 24 of FIG. 1 (and in some instances, control circuitry 14 of FIG. 1) configured to perform operations in accordance with satellite navigation system protocols, receive radio frequency signals having one or more frequencies in one or more satellite navigation frequency bands, and/or other operations for satellite navigations. Satellite navigation circuitry 52 may sometimes be referred to as a satellite navigation receiver as circuitry 52 receives satellite navigation signals from navigation satellites.

UWB wireless communication circuitry 52 may include portions of wireless circuitry 24 (as described in connection with FIG. 1) configured to perform operations in accordance with UWB protocols (e.g., the IEEE 802.15.4 protocol and/or other ultra-wideband communications protocols) and may generally transmit and/or receive radio-frequency signals having one or more frequencies in one or more UWB frequency bands (e.g., a frequency band between 6-8 GHz). These portions of wireless circuitry 24 may include baseband components, may include radio-frequency receiver components, may include radio-frequency front-end components, may include radio-frequency transmission line components, may include antennas, and/or may generally include any of the components in wireless circuitry 24 of FIG. 1 (and in some instances, control circuitry 14 of FIG. 1) configured to perform operations in accordance with UWB protocols, receive radio frequency signals having one or more frequencies in one or more UWB frequency bands, and/or other UWB-based operations such as spatial ranging. UWB wireless communication circuitry 52 may include and therefore may sometimes be referred to as a UWB frequency signal transmitter as circuitry 52 transmits UWB radio-frequency signals based on which the corresponding receiving device (e.g., user device 10A having corresponding UWB wireless communication circuitry) may perform spatial ranging operations.

Wireless circuitry 50 of tag 10B may include wireless personal area network (WPAN) wireless communication circuitry such as Bluetooth wireless communication circuitry 56. While illustrative configurations in which tag 10B includes Bluetooth wireless communication circuitry are sometimes described herein, this is merely illustrative. If desired, other WPAN wireless communication circuitry may be included instead of or in addition to Bluetooth wireless communication circuitry 56.

WPAN wireless communication circuitry such as circuitry 56 may include portions of wireless circuitry 24 (as described in connection with FIG. 1) configured to perform operations in accordance with protocols for short-range wireless communication links (e.g., the Bluetooth protocol or other wireless personal area network (WPAN) protocols) and may generally transmit and/or receive radio-frequency signals having one more frequencies in WPAN frequency bands (e.g., the 2.4 GHz Bluetooth band or other WPAN communications bands). These portions of wireless circuitry 24 may include baseband components, may include radio-frequency receiver components, may include radio-frequency front-end components, may include radio-frequency transmission line components, may include antennas, and/or may generally include any of the components in wireless circuitry 24 of FIG. 1 (and in some instances, control circuitry 14 of FIG. 1) configured to perform operations in accordance with WPAN (e.g., Bluetooth) protocol, transmit and receive radio frequency signals having one or more frequencies in one or more WPAN (e.g., Bluetooth) frequency bands, and/or perform other WPAN-based operations. Bluetooth wireless communication circuitry 56 may include and therefore may sometimes be referred to as a Bluetooth Low Energy transmitter as circuitry 56 transmits (e.g., broadcasts) beacon messages conveyed with radio-frequency signals based on which the corresponding receiving device (e.g., user device 10A and/or another device 10 in system 8 having corresponding Bluetooth wireless communication circuitry) may identify circuitry 56 and tag 10B. Bluetooth wireless communication circuitry 56 may also be used to wirelessly pair (e.g., connect) tag 10B to other nearby device(s) such as user device 10A.

Satellite wireless communication circuitry 58 may include portions of wireless circuitry 24 (as described in connection with FIG. 1) configured to perform operations in accordance with satellite communication protocols (e.g., for conveying bi-directional data with one or more gateways via one or more communications satellites or satellite base stations in a satellite constellation) and may generally transmit and/or receive radio-frequency signals having one or more frequencies in one or more satellite communication frequency bands. These portions of wireless circuitry 24 may include baseband components, may include radio-frequency receiver components, may include radio-frequency front-end components, may include radio-frequency transmission line components, may include antennas, and/or may generally include any of the components in wireless circuitry 24 of FIG. 1 (and in some instances, control circuitry 14 of FIG. 1) configured to perform operations in accordance with satellite communication protocols, transmit and receive radio frequency signals having one or more frequencies in one or more satellite communication frequency bands, and/or perform other satellite communication operations.

Sub-GHz wireless communication circuitry 60 may include portions of wireless circuitry 24 (as described in connection with FIG. 1) configured to perform operations in accordance with one or more communication protocols and may generally transmit and/or receive radio-frequency signals having one or more frequencies in one or more sub-GHz frequency bands (i.e., frequency bands containing frequencies less than 1 GHz). These portions of wireless circuitry 24 may include baseband components, may include radio-frequency receiver components, may include radio-frequency front-end components, may include radio-frequency transmission line components, may include antennas, and/or may generally include any of the components in wireless circuitry 24 of FIG. 1 (and in some instances, control circuitry 14 of FIG. 1) configured to perform operations in accordance with the one or more communication protocols, receive radio-frequency signals having one or more frequencies in one or more sub-GHz frequency bands, and/or perform other operations.

In some illustrative configurations described herein, sub-GHz (non-cellular) wireless communication circuitry 60 may operate (e.g., transmit and receive radio-frequency signals) in one or more ISM bands (e.g., an ISM band between around 900 MHz and 950 MHz) and may sometimes be referred to as ISM wireless communication circuitry. If desired, circuitry 60 may operate in other non-cellular frequency bands such as a band between around 800 MHz and 825 MHz, a band between around 860 MHz and 870 MHz, and/or other sub-GHz bands. As examples, circuitry 60 may transmit and/or receive radio-frequency signals in non-cellular sub-GHz frequency band(s) (e.g., to transmit or broadcast beacon messages, to listen for, detect, and receive radio-frequency signals in the frequency band(s) transmitted by user device 10A, to exchange messages to establish a sub-GHz wireless communication link with user device 10A, to transmit tag data such as tag location information indicative of real-time location and/or updates to the real-time location over the sub-GHz wireless communication link with user device 10A, to receive data over the sub-GHz wireless communication link from user device 10A, etc.).

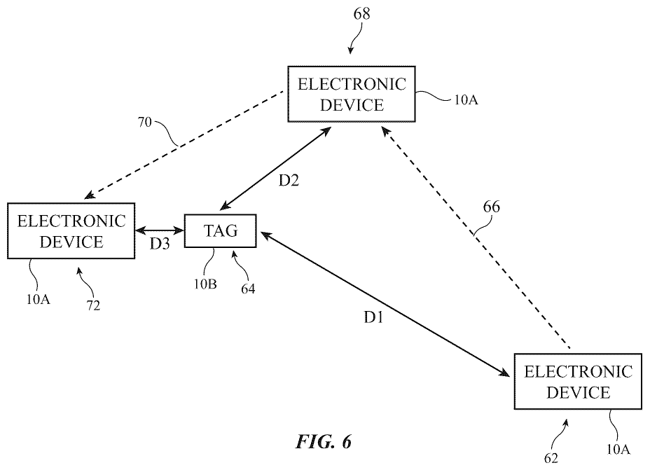

FIG. 6 is a diagram of an illustrative user device 10A and an illustrative tag 10B as user device 10A tracks the location of tag 10B. Initially, user device 10A may be located at location 62, while tag 10B is located at location 64. Accordingly, user device 10A and tag 10B may have a first separation (e.g., be separated by a distance of D1). While being separated from device 10A by distance D1, tag 10B may convey its location information via first non-cellular wireless communication circuitry to device 10A to guide the user of device 10A towards location 64 of tag 10B (e.g., by presenting the user with location information via a graphical user interface associated with tag software 48 and using display 32).

During the process of locating tag 10B at location 64 (or at an updated location), the user may relocate as indicated by arrow 66, and accordingly, user device 10A may move from location 62 to location 68. At this location, user device 10A and tag 10B may have smaller separation (e.g., be separated by a distance D2 less than distance D1). When separated by distance D2, user device 10A and tag 10B may be within range of each other to establish a direct (pear-to-peer) wireless communication link (e.g., using corresponding sub-GHz non-cellular wireless communication circuitry). Once the wireless communication link is established, tag 10B may convey its location information indicative of real-time location 64 (or an updated real-time location in other examples) to user device 10A. The location information received by user device 10A and presented to the user of device 10A (e.g., via a graphical user interface associated with tag software 48 and using display 32) may further guide the user to the location of tag 10B.

Continuing with the process of tracking tag 10B at location 64 (or at an updated location), the user may further relocate as indicated by arrow 70, and accordingly, user device 10A may move from location 68 to location 72. At this location, user device 10A and tag 10B may have an even smaller separation (e.g., be separated by a distance D3 less than distance D2). When separated by distance of D3, user device 10A and tag 10B may be within range of each other to perform precision finding operations. As part of these precision finding operations, tag 10B may provide more precise location information (e.g., using the transmission of radio-frequency signals for spatial ranging) to user device 10A, may provide audio output or other types of output to guide the user toward tag 10B, may provide output other information and/or signals to facilitate the user in finding tag 10B.

In other words, at varying degrees of separation between tag 10B and user device 10A, different mechanisms may be used to facilitate location tracking across the various distances. As examples, distance D2 may be a distance between 200-500 meters (m), a distance between 700-1500 m, a distance between 1-5 kilometers (km), a distance between 6-20 km, a distance greater than 50 m, a distance less than 50 km, and/or any other suitable distance, distance D3 may be a distance greater than 500 m, greater than 1500 m, greater than 5 km, greater than 20 km, greater than 50 km, or any other suitable distance, and distance D1 may be a distance less than 50 m, less than 200 m, less than 700 m, less than 1 km, less than 6 km, or any other suitable distance.

While various types of wireless communication may be used to facilitate the conveyance of tag data (e.g., location information of the tag) from tag 10B to device 10A across the varying degrees of separation, wireless communication based on using non-cellular wireless communication circuitry such as using non-cellular wireless communication circuitry 50 (FIG. 5) on tag 10B and corresponding wireless communication circuitry on user device 10A are described herein as an illustrative examples.

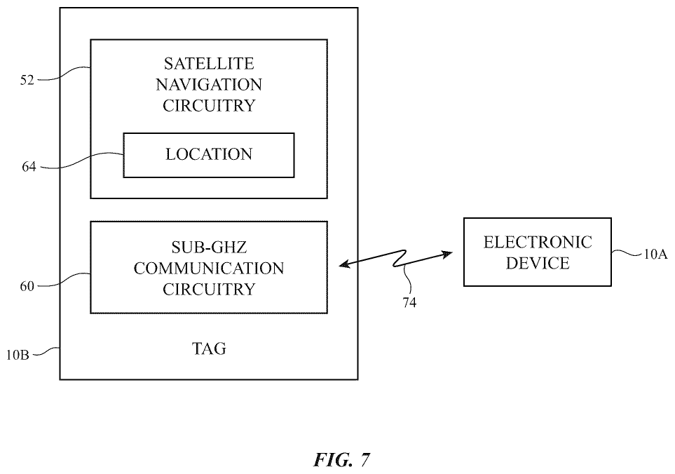

FIG. 7 is a diagram of illustrative non-cellular wireless communication circuitry used to convey tag data from tag 10B to device 10A (e.g., when separated by distance D2 in FIG. 6). When tag 10B and user device 10A are separated by a distance greater than the distance desired or needed to establish a wireless communication link 74 between tag 10B and device 10A, the control circuitry (e.g., control circuitry 14 implemented using components 38) of tag 10B may use communication circuitry 60 may listen for, detector, and/or receive radio-frequency signals (e.g., in one or more non-cellular sub-GHz bands) transmitted by device 10A such that wireless link 74 may be established once device 10A moves within range of establishing link 74.

In particular, the control circuitry and/or other components of tag 10B may wake communication circuitry 60 periodically to listen for the radio-frequency signals transmitted by device 10A and may, during other (intervening) time periods, place communication circuitry 60 in a low power mode (e.g., a sleep mode, a power off mode, etc.). As examples, communication circuitry 60 may wake once per 1 second(s), once per 2 s, once per 5 s, once per 6 s, once per 10 s, once every 30 s, wake with another regular periodicity, and/or may wake in response to one or more criteria (e.g. indicative of the setup of link 74 being requested) being met. If desired, communication circuitry 60 may transmit beacon messages (e.g., using radio-frequency signals at one or more frequencies in one or more non-cellular sub-GHz bands) to facilitate its discovery by user device 10A, its reception of radio-frequency signals from user device 10A, and/or generally the establishment of link 74.

Responsive to communication circuitry 60 receiving radio-frequency signals from device 10A or otherwise receiving an indication to establish link 74, the control circuitry of tag 10B may use communication circuitry 60 to exchange messages or other data (e.g., to perform a handshake operation, to exchange certificates and/or other cryptographic, security, and/or identifier information, etc.) with device 10A to establish link 74.

While link 74 remains active (e.g., is established and maintained), the control circuitry of tag 10B may provide (e.g., stream) tag data such as tag location information (e.g., real-time location and updates to the real-time location) to device 10A. In the example of FIG. 7, the control circuitry of tag 10B may use satellite navigation circuitry 52 to obtain tag location information such as a geographical location 64 of tag 10B. The control circuitry of tag 10B may provide the obtained tag location information to electronic device 10A using communication circuitry 60 and over link 74. The control circuitry of tag 10B may obtain and update real-time location information of tag 10B (e.g., using satellite navigation circuitry 52) with a desired periodicity, e.g., once per 1 second(s), once per 2 s, once per 5 s, once per 10 s, once per 30 s, etc. Accordingly, the control circuitry of tag 10B may provide (e.g., stream) real-time tag location information to device 10A using communication circuitry 60 and over link 74 (e.g., with the same periodicity with which the tag location is updated by satellite navigation circuitry 52).

In such a manner, the control circuitry of device 10A may receive (e.g., using corresponding wireless communication circuitry on device 10A) frequently updated real-time location 74 of tag such that a moving tagged item can be more easily tracked and subsequently located, even when the tagged item has moved relatively far away from device 10A (e.g., the separation of distance D2 is outside of the range of UWB communication, outside of range of a Bluetooth wireless communication link between tag 10B and device 10A, etc.). In particular, the control circuitry of device 10A (e.g., executing tag software 48) may present the obtained real-time location of tag 74 to a user (e.g., using display 32 and/or other output devices) to guide the user toward tag 10B and the tagged item.

Configurations in which tag 10B is or forms at least part of a tracking device for an animal (e.g., a pet) or other dynamic (moving) subject or item are sometimes described herein as an example. The use of non-cellular wireless communication circuitry and/or a direct peer-to-peer wireless communication link using sub-GHz frequencies in this manner (e.g. using link 74 to convey location information obtained from satellite navigation circuitry 52) may help with tag location conveyance with low latency (e.g., frequent updates to real-time location), high location accuracy, and across a large distance, while reducing power consumption (e.g., when compared with the use of a cellular connection).

While the control circuitry of tag 10B may use communication circuitry 60 to provide device 10A with real-time location information of tag 10B for presentation to a user at device 10A, direct wireless communication link 74 may have a maximum range (e.g., within which communication link 74 can be established, within which data can be reliable conveyed, etc.). Accordingly, beyond a maximum separation (e.g., at a separation of distance D3), other wireless communication circuitry (e.g., other non-cellular wireless communication circuitry 50) may facilitate the conveyance of location information of tag 10B to device 10A in guiding the user of device 10A to a distance less than the maximum separation in order to facilitate the establishment of link 74.

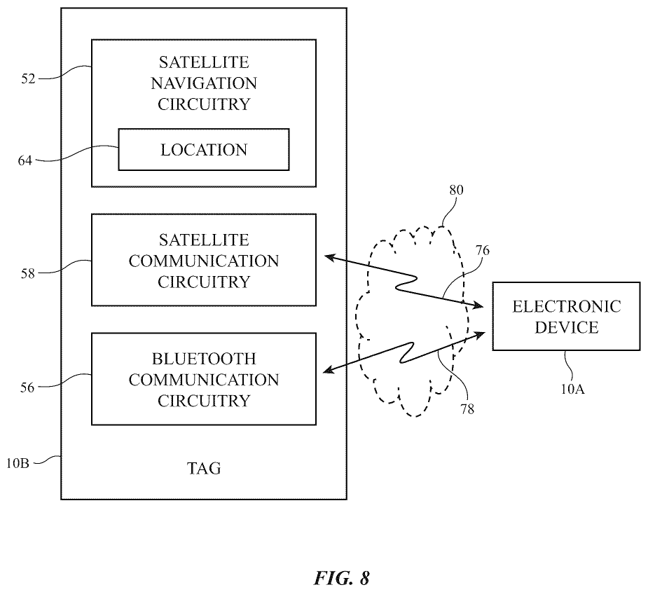

FIG. 8 is a diagram of illustrative non-cellular wireless communication circuitry used to convey tag data from tag 10B to device 10A (e.g., when separated by a distance greater than distance D2 and/or when separated by distance D3 in FIG. 6). In particular, the control circuitry of tag 10B may use satellite communication circuitry 58 may convey tag data such as tag location information (e.g., tag location 64 obtained using satellite navigation circuitry 52). Satellite communication circuitry 58 may convey the tag data using a communication path such as path 76.

As an example, path 76 may include one or more satellite or non-terrestrial base stations and other network nodes in a non-terrestrial network and/or may include one or more other networks (e.g., network 42 in FIG. 4). In particular, communication path 76 may include a direct wireless communication link from communication circuitry 58 to a satellite base station. The control circuitry of tag 10B may provide tag location information to the satellite base station for subsequent conveyance to device 10A (e.g., through intervening network nodes or other intervening equipment). Satellite-based communication path 76 may be characterized by higher transmission overhead (e.g., higher power consumption), and as such, tag location information may be obtained by the control circuitry of tag 10B (e.g., using satellite navigation circuitry 52) and conveyed to device 10A (e.g., using satellite communication circuitry 58) with a moderate frequency (e.g., a reduced frequency than when using communication circuitry 60 in FIG. 7). As examples, the control circuitry of tag 10B may obtain and convey the real-time tag location information with a periodicity of, e.g., once per 1 minute (min), once per 2 min, once per 5 min, once per 10 min, once per 30 min, etc.

If desired, in addition to or instead of the use of satellite communication circuitry 58 to convey tag data (e.g., at distances beyond the range of link 74), the control circuitry of tag 10B may use Bluetooth communication circuitry 56 to indicate tag location information to device 10A. Configurations in which Bluetooth communication circuitry 56 is used are sometimes described herein as an example. If desired, other types of WPAN communication circuitry instead of or in addition to communication circuitry 56 included in tag 10B to convey tag data.

In the example of FIG. 8, the control circuitry of tag 10B may use communication circuitry 56 to convey tag data to one or more nodes or terminals of a network (e.g., one or more other electronic devices 10A coupled to network 42 in FIG. 4). The conveyed tag data may be used to obtain tag location information that is subsequently conveyed to device 10A (e.g., with or without being processed by server 44 and/or other devices 10A in FIG. 4). The transmission of tag data using communication circuitry 56 and/or the reception of the same data or other processed tag information (e.g., generated tag location information) by device 10A may utilize communication paths 78 such as one or more wireless communication links based on radio-frequency signals 46 in FIG. 4 (e.g., between tag 10B and neighboring devices such as additional instances of device 10A other than device 10A in FIG. 8), network paths within one or more networks 80 (e.g., network 42 in FIG. 4), etc. If desired, as with using satellite communication circuitry 58, communication circuitry 56 may be used to convey location information (e.g., indicative of location 64) as tag data to neighboring devices and subsequently to device 10A using path(s) 78.

The tag location information received by device 10A based on paths 76 and/or 78 may be used by the control circuitry of device 10A (e.g., when executing tag software 48) to present the received tag location information to a user as user output. The presented tag location information may help guide the user of device 10 toward tag 10B even while separated by a large distance (e.g., a separation of distance D3). When the separation is reduced to a distance (e.g., distance D2) to facilitate a direct sub-GHz wireless communication link, communication circuitry 60 may be used to provide lower latency real-time location information of tag 10B (as described in connection with FIG. 7).

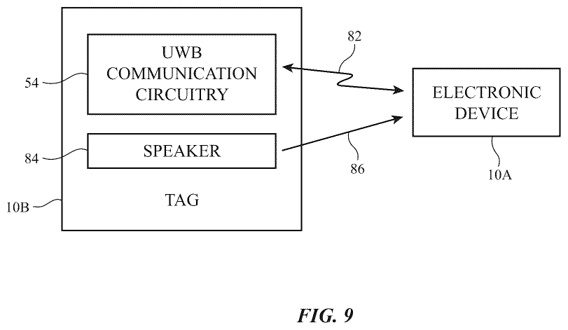

Once the separation between tag 10B and device 10A approaches distance DI (FIG. 6), other, more precise and/or higher resolution, techniques may be used to facilitate the locating of tag 10B by the device 10A (and consequently the finding of tag 10B by a user of device 10A). FIG. 9 is a diagram of illustrative non-cellular wireless communication circuitry and other output devices that may be used to convey tag data or other output from tag 10B to device 10A (or generally to the environment surrounding tag 10B), e.g., when separated by a distance less than distance D2 and/or when separated by distance D1 in FIG. 6.

In the example of FIG. 9, the control circuitry of tag 10B may use UWB communication circuitry 54 to convey (e.g., transmit) radio-frequency signals indicative of tag location information to device 10A over communication link 82. Based on the received radio-frequency signals, device 10A may perform a spatial ranging operation to determine a distance, a direction, and/or other characteristics of the separation between tag 10B and device 10A. If desired, other output circuitry (e.g., output devices 22) of tag 10B may be used by the control circuitry of tag 10B to convey indications of tag location to device 10A and/or the user of device 10A. As an example, the control circuitry may control speaker 84 or other audio output devices to produce audio output 86 into the environment surrounding tag 10B such that the user of device 10A can hear audio output 86 to locate tag 10B. As desired, lights or visual output devices, haptic output devices, and/or other output devices of tag 10B may be controlled by the control circuitry to produce corresponding output to assist the user of device 10A in locating tag 10B.

The operations performed by tag 10B to provide tag location information (e.g., to transmit radio-frequency signals using UWB communication circuitry 54 to facilitate spatial ranging, to produce audio output by speaker 84, and/or to perform other precision finding operations) may be triggered or otherwise caused by device 10A. For example, device 10A may send commands or other types of instructions to tag 10B that when processed by the control circuitry of tag 10B causes tag 10B to the provide the tag location information.

In order to reduce unnecessary power consumption, it may be desirable to activate different sets of components and/or circuitry (e.g., to enable the non-cellular wireless communication circuitry to perform the corresponding operations described in connection with FIGS. 7-9) based on respective sets of criteria being met, e.g., as determined by the control circuitry of tag 10B. In some illustrative configurations described herein as examples, the criteria may include one or more criteria based on a geographical location of tag 10B, one or more criteria based on a pairing or connectivity of tag 10B to device 10A, one or more criterion based on a relative location of tag 10B with respect to a location of device 10A, and/or one or more other criteria (sometimes referred to as trigger conditions).

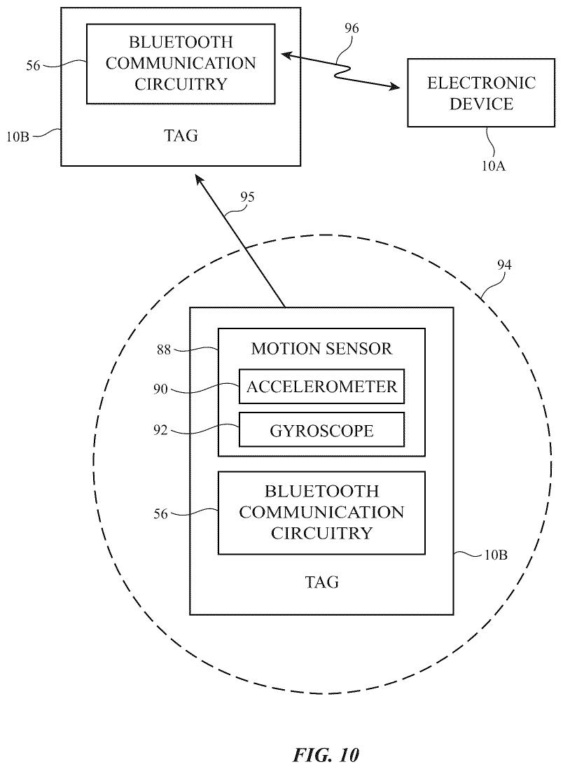

FIG. 10 is a diagram of an illustrative tag moving across a geographical boundary (e.g., associated with a geofence) and/or wirelessly paired with a user device. As shown in FIG. 10, tag 10B may initially be located within a geographical area within boundary 94. Boundary 94 may be a virtual perimeter (e.g., a geofence) overlapping a geographical region which when crossed by tag 10B causes one or more criteria to be met and consequently causes tag 10B to perform one or more actions. In illustrative configurations described herein as examples, responsive to the control circuitry of tag 10B determining that one or more criteria indicative of tag 10B crossing outside of boundary 94 having been met, the control circuitry of tag 10B may activate one or more types of non-cellular wireless communication circuitry to facilitate conveyance of tag data to device 10A and/or to perform other operations (e.g., cause communication circuitry 60 or other wireless communication circuitry to transmit beacon message(s)). As examples, satellite navigation circuitry 52 in FIG. 7, sub-GHz wireless communication circuitry 60 in FIG. 7, satellite wireless communication circuitry 58 in FIG. 8, Bluetooth wireless communication circuitry 56 in FIG. 8, UWB wireless communication circuitry 54, other types of wireless communication circuitry, and/or other output devices such as speaker 84 of tag 10B may be activated or otherwise enabled by the control circuitry of tag 10B to perform operations for conveying tag location information to device 10A (e.g., as described in connection with FIGS. 7-9).

Boundary 94 may be a static boundary or may be a dynamic boundary 94 that changes over time (e.g., enclose different geographical areas over time) based on information gathered by tag 10B and/or electronic device 10A, based on information gathered for the tagged item and/or the user of electronic device 10A, and/or based on other information. As examples, boundary 94 may overlap and/or enclose the boundaries of a house, the boundaries of a yard, the boundaries of a park, and/or the boundaries of any geographical area in which tag 10B and/or the tagged item is expected to be located (e.g., for the majority of the time).

In some illustrative configurations described herein as an example, tag 10B may include a motion sensor such as motion sensor 88 having accelerometer 90 and gyroscope 92. Motion sensor 88 may detect a movement of tag 10B (e.g., using accelerometer 90) within boundary 94 and/or may track using accelerometer 90 and gyroscope 92 (e.g., upon detecting the movement), a location of tag 10B within boundary 94 (e.g., a relative placement or location of tag 10B with respect to boundary 94, thereby indicating whether or not tag 10B remains within boundary 94). Accordingly, the control circuitry of tag 10B may use motion sensor 88 to gather sensor data in determining whether one or more criteria indicative of tag 10B crossing boundary 94 has been met (e.g., when the (processed) sensor data is determined to meet one or more criteria).

In some instances, tag 10B may be wireless paired with (e.g., have an established wireless communication link with) device 10A using WPAN wireless communication circuitry (e.g., Bluetooth communication circuitry 56). In one illustrative scenario shown in FIG. 10, while tag 10B may have crossed boundary 94 and left the geographical area enclosed therein, Bluetooth communication circuitry 56 on tag 10B may be wirelessly paired (connected) to corresponding (e.g., Bluetooth) communication circuitry on device 10A over a wireless communication link 96 (e.g., a communication link indicative of a Bluetooth pairing between tag 10B and device 10A). In this illustrative scenario, the conveyance of tag location information to device 10A may not be needed (e.g., even when tag 10B is outside of boundary 94) as the maintained connection over link 96 may be indicative of the user of electronic device 10A being in close proximity with the tagged item and/or is therefore aware of the location of the tagged item.

However, once the connection over link 96 is lost and/or tag 10B is otherwise disconnected from device 10A as indicated by one or more criteria having been met (and tag 10B is determined to be outside of boundary 94), wireless communication circuitry (e.g., one or more types of non-cellular wireless communication circuitry 50) and/or other output devices of tag 10B may be activated or otherwise enabled by the control circuitry of tag 10B to perform operations for conveying tag location information to device 10A (e.g., described in connection with FIGS. 7-9).

While the example of FIG. 10 describes the connectivity between tag 10B and device 10A over link 96 being in combination with tag 10B crossing a geofence (e.g., boundary 94), the two types of criteria may be used independently. As an example, in a configuration where a geofence trigger condition (e.g., one or more criteria being met based on tag 10B crossing boundary 94) is not set, the control circuitry of tag 10B may still determine whether or not to activate wireless communication circuitry and/or output devices on tag 10B (e.g., described in connection with FIGS. 7-9) based on the status of link 96 (e.g., based on one or more criteria that are met when link 96 is severed and there is no corresponding wireless pairing between device 10A and tag 10B). If desired, other trigger conditions or criteria may be used in addition to or instead of those based on leaving a geofence and/or based on a disconnection of the pairing between tag 10B and device 10A.

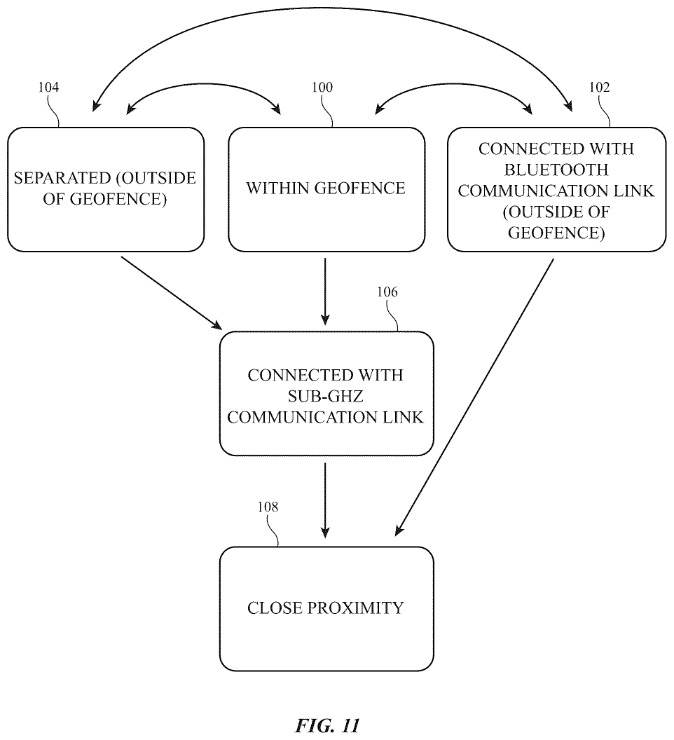

FIG. 11 is a diagram of illustrative modes in which a tracking device such as tag 10B can operate to efficiently convey location information to a user device when desired. As shown in FIG. 11, the control circuitry of tag 10B may operate in a first mode 100 when tag 10B is within a geofence, may operate in a second mode 102 when tag 10B is connected to user device 10A via a Bluetooth wireless communication link (and outside of the geofence), may operate in a third mode 104 when tag 10B is separated from user device 10A (and outside of the geofence), may operate in a fourth mode 106 when tag 10B is connected to user device 10A via a non-cellular sub-GHz wireless communication link, and may operate in a fifth mode 108 when tag 10B is in close proximity to user device 10A.

When operating in mode 100, the control circuitry of tag 10B may not convey tag location information to device 10A but may monitor a location of tag 10B to determine when the control circuitry of tag 10B should transition operation from mode 100 to another mode of operation (e.g., mode 102, mode 104, mode 106, or other modes of operation). As an example, when operating in mode 100, the control circuitry of tag 10B may perform the operations described in connection with FIG. 10 when tag 10B is located within boundary 94.

When operating mode 102, the control circuitry of tag 10B may not convey tag location information to device 10A but may monitor the wireless pairing status with device 10A to determine when the control circuitry of tag 10B should transition operation from mode 102 to another mode of operation (e.g., mode 100, mode 104, mode 108, or other modes of operation). As an example, when operating in mode 102, the control circuitry of tag 10B may perform the operations described in connection with FIG. 10 when tag 10B is wirelessly paired with user device 10A.

When operating mode 104, the control circuitry of tag 10B may use first non-cellular wireless communication circuitry to convey tag location information to device 10A and may determine when the control circuitry of tag 10B should transition operation from mode 104 to another mode of operation (e.g., mode 100, mode 102, mode 106, or other modes of operation). As an example, when operating in mode 104, the control circuitry of tag 10B may perform the operations described in connection with FIG. 8 and/or the operations described in connection with FIG. 6 when the separation between tag 10B and device 10A is distance D3.

When operating mode 106, the control circuitry of tag 10B may use second non-cellular wireless communication circuitry to convey tag location information to device 10A and may determine when the control circuitry of tag 10B should transition operation from mode 106 to another mode of operation (e.g., mode 108 or other modes of operation). As an example, when operating in mode 106, the control circuitry of tag 10B may perform the operations described in connection with FIG. 7 and/or the operations described in connection with FIG. 6 when the separation between tag 10B and device 10A is distance D2.

When operating mode 108, the control circuitry of tag 10B may use third non-cellular wireless communication circuitry to convey tag location information to device 10A. As an example, when operating in mode 108, the control circuitry of tag 10B may perform the operations described in connection with FIG. 9 and/or the operations described in connection with FIG. 6 when the separation between tag 10B and device 10A is distance DI.

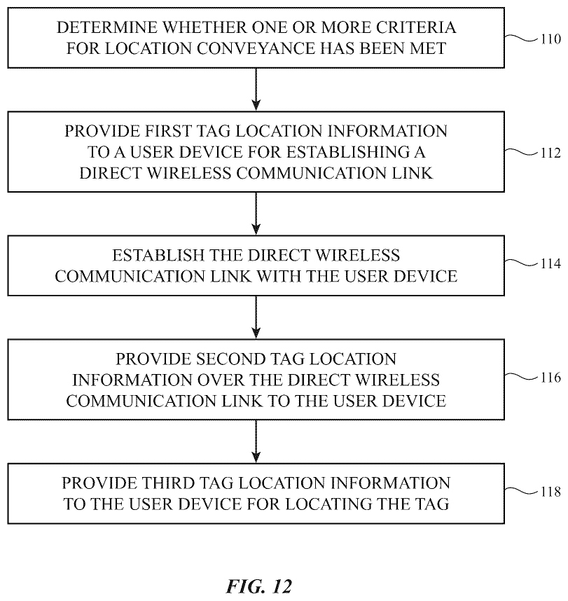

FIG. 12 is a flowchart of illustrative operations for conveying location information of a tracking device (e.g., tag 10B). In some illustrative configurations described herein, the operations may be performed by one or more components of tag 10B. As an example, the operations may be performed by one or more processors of the control circuitry of tag 10B, by executing corresponding software instructions stored on storage circuitry of the control circuitry of tag 10B. The performance of at least some of these operations may involve (e.g., include) operations performed by a corresponding user device tracking a location of tag 10B (e.g., user device 10A) and/or one or more intervening devices coupled between tag 10B and the user device.

At block 110, control circuitry (e.g., of tag 10B) may determine whether one or more criteria for conveying location information of a tag 10B has been met. Responsive to the one or more criteria being met, processing may proceed to block 112. As illustrative examples, the one or more criteria may include a criterion that is met when tag 10B crosses a geographical boundary and/or a criterion that is met when tag 10B is not wireless paired with a corresponding user device.

At block 112, the control circuitry may provide first tag location information (e.g., indicative of a real-time location of tag 10B) to a user device. In particular, the control circuitry may use first non-cellular wireless communication circuitry such as satellite communication circuitry to convey the first tag location information (e.g., using a satellite-based wireless communication link with a satellite base station, through network 42 in FIG. 4, etc.). If desired, the control circuitry may use second non-cellular wireless communication circuitry such as WPAN (e.g., Bluetooth) communication circuitry to convey the first tag location information and/or other information indicative of tag location (e.g., using a Bluetooth-based wireless communication link with an intervening electronic device, through network 42 in FIG. 4, through server 44, etc.).

Based on the conveyance of the first tag location information to device 10A and the subsequent presentation of the first tag location information to a user of device 10A, the first tag location information may help guide the user of device 10A to reach a location (e.g., location 68 in FIG. 6) for facilitating the establishing of a direct wireless communication link.

At block 114, the control circuitry may establish the direct wireless communication link with the user device. In particular, the control circuitry may use third non-cellular wireless communication circuitry such as sub-GHz communication circuitry to periodically listen for and detect (e.g., receive) radio-frequency signals transmitted by user device 10A (e.g., carried by user to a location within range of establishing the direct wireless communication link). Upon receiving the transmitted radio-frequency signals, the control circuitry may use the sub-GHz communication circuitry to respond and/or otherwise exchange messages with corresponding wireless communication circuitry on user device 10A to establish and maintain the direct wireless communication link (e.g., a non-cellular sub-GHz direct wireless communication link).

At block 116, the control circuitry may provide second tag location information (e.g. indicative of the same location or a different location of tag 10B from the location of tag 10B indicated by the first tag location information in block 112) over the direct wireless communication link to the user device. As an example, the control circuitry may use satellite navigation circuitry to obtain real-time location and any updates to the real-time location and convey, using the sub-GHz wireless communication circuitry and over the direct wireless communication link, the real-time location and its updates. If desired, other information may be similarly conveyed using the sub-GHz wireless communication circuitry and over the direct wireless communication link.

Based on the conveyance of the second tag location information to device 10A and the subsequent presentation of the second tag location information to a user of device 10A, the second tag location information may help guide the user of device 10A to reach another location (e.g., location 72 in FIG. 6) for facilitating the performance of precision finding operations.

At block 118, the control circuitry may provide third tag location information (e.g. indicative of the same location or a different location of tag 10B from the location of tag 10B indicated by the first and third tag location information in blocks 112 and 116) to the user device for precisely location and finding the tag. As examples, the control circuitry may use fourth non-cellular wireless communication circuitry (e.g., UWB wireless communication circuity), audio output devices (e.g., speakers), and/or other output devices to output third tag location information (e.g., UWB radio-frequency signals, audio output, and/or other output indicative of a location of the tag).

As described above, one aspect of the present technology is the gathering and use of information such as information from tracking devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. A tracking device operable with an electronic device that provides user output indicative of a location of the tracking device, the tracking device comprising:
satellite navigation circuitry configured to obtain location information of the tracking device; and
non-cellular wireless communication circuitry configured to:
establish, based on the tracking device being outside of a geographical area, a direct wireless communication link with the user device, and
provide, over the direct wireless communication link, the obtained location information of the tracking device to the user device.

2. The tracking device defined in claim 1, wherein the non-cellular wireless communication circuitry comprises sub-GHz non-cellular wireless communication circuitry.

3. The tracking device defined in claim 2 further comprising:
additional non-cellular wireless communication circuitry configured to convey tag data indicative of the location of the tracking device prior to the establishment of the direct wireless communication link.

4. The tracking device defined in claim 3, wherein the tag data indicative of the location of the tracking device comprises the location information of the tracking device and wherein the additional non-cellular wireless communication circuitry comprises satellite wireless communication circuitry configured to provide the obtained location information to the user device prior to the establishment of the direct wireless communication link.

5. The tracking device defined in claim 3, wherein the additional non-cellular wireless communication circuitry comprises wireless personal area network communication circuitry configured to convey the tag data indicative of the location of the tracking device to a neighboring electronic device other than the electronic device prior to the establishment of the direct wireless communication link.

6. The tracking device defined in claim 2 further comprising:
input-output circuitry configured to output additional location information of the tracking device after the establishment of the direct wireless communication link.

7. The tracking device defined in claim 6, wherein the input-output circuitry configured to output the additional location information of the tracking device responsive to a command from the electronic device.

8. The tracking device defined in claim 6, wherein the input-output circuitry comprises ultra-wideband wireless communication circuitry configured to convey radio-frequency signals indicative of the location of the tracking device.

9. The tracking device defined in claim 6, wherein the input-output circuitry comprises an audio output device configured to produce audio output indicative of the location of the tracking device.

10. The tracking device defined in claim 2, wherein the sub-GHz non-cellular wireless communication circuitry is configured to detect radio-frequency signals at a frequency less than 1 GHz transmitted by the electronic device prior to the establishment of the direct wireless communication link.

11. The tracking device defined in claim 10 further comprising:
control circuitry configured to determine whether a criterion has been met and configured to enable the sub-GHz non-cellular wireless communication circuitry to detect the radio-frequency signals based on the criterion being met.

12. The tracking device defined in claim 11, wherein the criterion is indicative of the tracking device being outside of the geographical area.

13. The tracking device defined in claim 11, wherein the criterion is indicative of whether the tracking device is wirelessly paired with the electronic device.

14. A tracking device comprising:
a motion sensor configured to gather sensor data;
sub-GHz non-cellular wireless communication circuitry; and
control circuitry configured to:
enable the sub-GHz non-cellular wireless communication circuitry to establish a wireless communication link with external equipment based on the gathered sensor data meeting one or more criteria indicative of the tracking device crossing a geographical boundary, and
provide a real-time location of the tracking device over the wireless communication link to the external equipment.

15. The tracking device defined in claim 14 further comprising:
satellite navigation circuitry, wherein the control circuitry is configured to obtain the real-time location of the tracking device and updates to the real-time location of the tracking device using the satellite navigation circuitry and wherein the control circuitry is configured to provide the updates to the real-time location over the wireless communication link to the external equipment.

16. The tracking device defined in claim 14 further comprising:
additional non-cellular wireless communication circuitry, wherein the control circuitry is configured to enable the additional non-cellular wireless communication circuitry to convey tag data based on the gathered sensor data meeting the one or more criteria indicative of the tracking device crossing the geographical boundary.

17. The tracking device defined in claim 16, wherein the additional non-cellular wireless communication circuitry comprises satellite wireless communication circuitry and wherein the control circuitry is configured to provide, using the satellite wireless communication circuitry, the real-time location of the tracking device to the external equipment when the wireless communication link is not established.

18. The tracking device defined in claim 17, wherein the real-time location of the tracking device provided using the satellite wireless communication circuitry is updated with a first frequency and wherein the real-time location of the tracking device provided over the wireless communications link is updated with a second frequency greater than the first frequency.

19. A tag for location tracking of an item coupled to the tag, the tag comprising:
satellite navigation circuitry configured to obtain location information of the tag;
first non-cellular wireless communication circuitry configured to convey the location information to an external device when the external device is separated from the tag by a first distance; and
second non-cellular wireless communication circuitry configured to:
establish a direct wireless communication link with the external device, and
convey the location information to the external device using the direct wireless communication link when the external device is separated from the tag by a second distance less than the first distance and based on the tag having crossed a geographical boundary.

20. The tag defined in claim 19, wherein the first non-cellular wireless communication circuitry comprises satellite wireless communication circuitry and wherein the second non-cellular wireless communication circuitry comprises sub-GHz wireless communication circuitry.
